(19) United States
(12) Patent Application Publication
(10) Pub. No.: US 2026/0303884 A1
(43) Pub. Date: Oct. 1, 2026

(54) STREAMING APPARATUS, STREAMING METHOD, AND STORAGE MEDIUM

(71) Applicant: HONDA MOTOR CO., LTD., Tokyo (JP)

(72) Inventor: Junichiro Onaka, Tokyo (JP)

(21) Appl. No.: 19/568,057

(22) Filed: Mar. 16, 2026

(30) Foreign Application Priority Data
Mar. 28, 2025 (JP) 2025-056381

(51) Int. Cl. H04N 21/2343; G06F 3/14; H04N 21/214; H04N 21/239; H04N 21/258; H04N 21/414; H04N 21/442

(52) U.S. Cl. CPC H04N 21/234363; G06F 3/1454; H04N 21/214; H04N 21/2393; H04N 21/25875; H04N 21/41407; H04N 21/44218

(57) ABSTRACT

A streaming server configured to: acquire a user ID included in a streaming request and device information; when a display device indicated by the device information is a first display device, receive, from the first display device, movement information indicating movement of a head of a user on which the first display device is mounted; determine, based on the received movement information, a range of a captured image to be streamed as a streaming image; and stream, to the first display device, the captured image in the determined range as the streaming image, wherein even when the movement information includes movement of the head of the user in an up-down direction, the streaming server does not change the range of the captured image to be streamed as the streaming image in the up-down direction in accordance with the movement of the head of the user in the up-down direction.

### INCORPORATION BY REFERENCE

The present application claims priority under 35 U.S.C. § 119 to Japanese Patent Application No. 2025-056381 filed on Mar. 28, 2025. The content of the application is incorporated herein by reference in its entirety.

### BACKGROUND OF THE INVENTION

### Field of the Invention

The present invention relates to a streaming apparatus, a streaming method, and a storage medium.

### Description of the Related Art

In recent years, efforts have been accelerating to provide access to sustainable transportation systems that take into account vulnerable traffic participants such as the elderly, people with disabilities, and children. To this end, efforts are focused on research and development for further improving the safety and convenience of traffic through the development of means of transportation for vulnerable road users.

For example, a method is conceivable of viewing a moving image streamed by a streamer of a video, without a person in a vulnerable position personally having to enter a mobile body to access a transportation system. By viewing the moving image streamed by the streamer, it is possible to experience the feeling of going out or traveling.

For example, Japanese Patent Laid-Open No. 2012-160898 discloses an image processing apparatus that performs image processing on a camera image that is captured by a camera mounted on the head of an observer along with a head-mounted display, and obtained by capturing a subject in the real external world that the observer is observing along with an image displayed on the head-mounted display.

However, when transferring the image displayed on the head-mounted display to another display device so that the image can also be viewed on the other display device, there is a problem in that a user viewing with the other display device may experience dizziness due to image shaking.

The present invention was made in view of the above-described circumstances and has an object to reduce the dizziness experienced by the user viewing the streaming image. Therefore, through a service for connecting remote locations and vehicles, the present invention contributes to supporting good connection between urban areas and regional areas such as those surrounding urban areas, and to the development of sustainable transportation systems.

### SUMMARY OF THE INVENTION

A streaming apparatus according to an aspect of the present disclosure includes: a communication unit configured to receive a streaming request; a storage unit configured to: store, in association with each other, user identification information for identifying a user and device information for identifying a display device used by the user; and store a captured image for streaming received from a streamer terminal; and a control section configured to: acquire user identification information included in the streaming request and device information; receive, from a display device, movement information indicating movement of the display device indicated by the acquired device information; determine, based on the received movement information, a range of the captured image to be streamed as a streaming image; and stream, to the display device, the captured image in the determined range as the streaming image, wherein when the movement information includes movement in an up-down direction, the control section makes the range of the captured image to be streamed as the streaming image smaller than a range of the movement in the up-down direction indicated by the movement information or does not change the range of the captured image in the up-down direction.

According to the present disclosure, even when determining a range of a captured image to be streamed as a streaming image in accordance with movement of the head of a user, it is possible to suppress dizziness experienced by a user viewing the streaming image, since the range of the captured image is not changed in accordance with movement of the head of the user in an up-down direction.

### BRIEF DESCRIPTION OF THE DRAWINGS

FIG. 1 is a diagram showing a system configuration of a streaming system;

FIG. 2 is a block diagram showing a configuration of an in-vehicle apparatus and a streaming server;

FIG. 3 is a diagram showing a configuration of a user registration database;

FIG. 4 is a diagram showing a configuration of a stream management database;

FIG. 5 is a block diagram showing a configuration of a streamer terminal;

FIG. 6 is a block diagram showing a configuration of a first display device;

FIG. 7 is a block diagram showing a configuration of a second display device;

FIG. 8 is a flowchart showing an operation of the streaming server; and

FIG. 9 is a flowchart showing the operation of the streaming server.

### DETAILED DESCRIPTION OF THE INVENTION

Hereinafter, an embodiment of the present invention will be described with reference to the drawings.

### Embodiment

### 1. Configuration of Streaming System

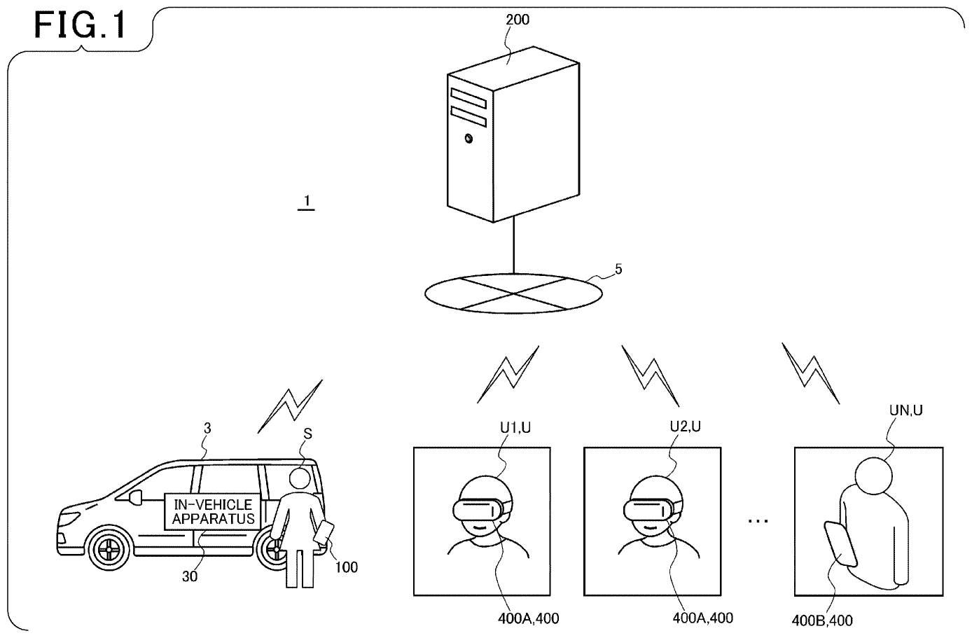

FIG. 1 is a diagram showing a system configuration of a streaming system 1.

The streaming system 1 includes an in-vehicle apparatus 30, a streamer terminal 100 used by a streamer S, a streaming server 200, and a display device 400 used by a viewer U. The streaming system 1 is a system for live streaming content including an image captured by the streamer terminal 100.

Live streaming refers to an activity in which a streamer and an unspecified viewer participate, and an image based on a capturing result from the streamer terminal 100 is streamed in real-time to the display device 400. The image may be a still image or a moving image.

The in-vehicle apparatus 30 is installed in a vehicle 3 and is wirelessly connected via short-range wireless communication or the like to the streamer terminal 100 possessed by the streamer S being a passenger of the vehicle 3.

The in-vehicle apparatus 30 receives, from the streamer terminal 100, content data including an images captured by a camera included in the streamer terminal 100 and speech input via a microphone included in the streamer terminal 100. The in-vehicle apparatus 30 uploads the received content data to the streaming server 200.

The streamer terminal 100 may be a smartphone or tablet personal computer (PC), or may be a camera such as a digital camera or a 360-degree camera capable of capturing an entire surrounding area. In this case, the microphone and the camera may be implemented separately.

The streaming server 200 stores the content received from the in-vehicle apparatus 30 in a server storage unit. The streaming server 200 streams the uploaded content data to the display device 400 of the viewer U. Live streaming technology can be realized using known technology such as HTTP Live Streaming (HLS), Common Media Application Format (CMAF), Web Real-Time Communication (WebRTC), or Real-Time Messaging Protocol (RTMP).

The display device 400 is a terminal apparatus possessed by the viewer U that watches the content data streamed from the streaming server 200. FIG. 1 shows U1, U2, . . . , UN viewers U as the viewer U. N is an arbitrary natural number. FIG. 1 shows, as the display device 400, a head-mounted first display device 400A worn on the head by viewers U1 and U2, and a second display device 400B possessed by a viewer UN.

The display device 400 includes the first display device 400A and the second display device 400B. The first display device 400A is a head-mounted display device in which an image display part displaying an image is mounted on the head of the viewer U. The first display device 400A may be transmissive or non-transmissive, as long as the content streamed from the streaming server 200 can be viewed.

The second display device 400B is a non-head-mounted display device in which an image display part is not mounted on the head of viewer U. For example, the second display device 400B may be a portable or mobile terminal apparatus such as a smartphone, tablet PC, or notebook PC, or may be a stationary terminal apparatus such as a desktop PC.

A communication network 5 is a wired or wireless transmission path for information transmitted from an apparatus connected to the communication network 5. For example, the communication network 5 may include a public network such as the Internet, a mobile communication network, a satellite communication network, or various local area networks (LANs) including Ethernet (registered trademark) or a wide area network (WAN). The communication network 5 may include a dedicated network such as an Internet protocol-virtual private network (IP-VPN).

### 2. Configuration of In-Vehicle Apparatus

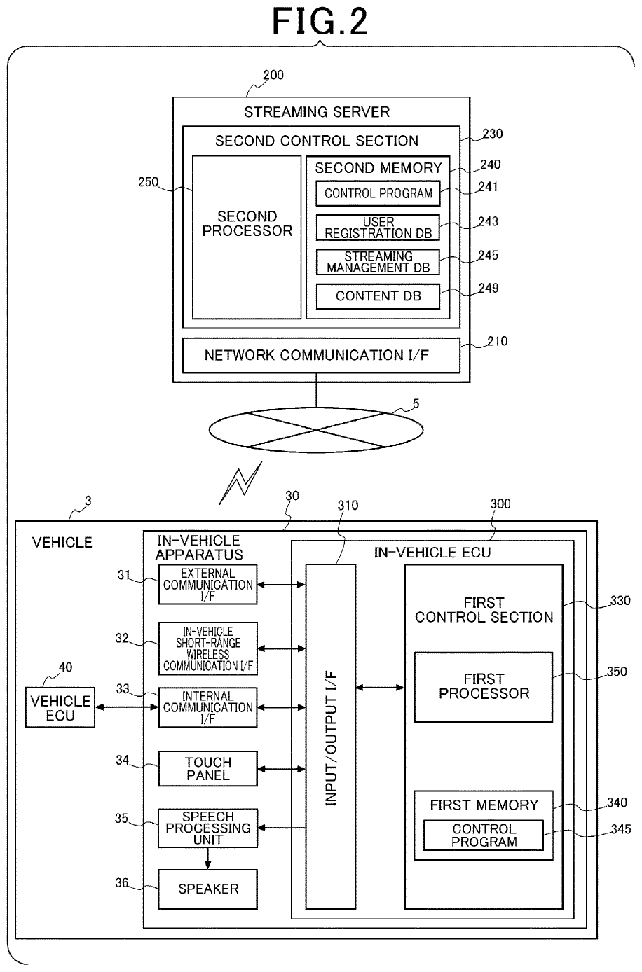

FIG. 2 is a diagram showing a configuration of the in-vehicle apparatus 30 and the streaming server 200.

First, the configuration of the in-vehicle apparatus 30 will be described with reference to FIG. 2.

The in-vehicle apparatus 30 includes an external communication interface 31, an in-vehicle short-range wireless communication interface 32, an internal communication interface 33, a touch panel 34, a speech processing unit 35, a speaker 36, and an in-vehicle electronic control unit (ECU) 300. Hereinafter, interface will be abbreviated as I/F.

The external communication I/F 31 is a communication module that performs wireless communication in accordance with a mobile communication standard such as long-term evolution (LTE), fourth-generation (4G), 5G, or Wi-Fi (registered trademark). The external communication I/F 31 is connected to the communication network 5 via an antenna (not shown) and performs mutual data transmission/reception with the streaming server 200.

For example, the in-vehicle short-range wireless communication I/F 32 is a communication module that performs communication in accordance with a near-field communication (NFC) standard such as Bluetooth (registered trademark) or Wi-Fi. The in-vehicle short-range wireless communication I/F 32 performs short-range wireless communication with a terminal apparatus possessed by a passenger and receives an image, speech, and the like captured by the terminal apparatus.

The internal communication I/F 33 is an input/output interface connected to an in-vehicle network (not shown). For example, a communication bus supporting a communication standard such as controller area network (CAN), CAN with Flexible Data-Rate (CAN FD), or Ethernet (registered trademark) is used for the in-vehicle network. The internal communication I/F 33 performs mutual data communication via the in-vehicle network with in-vehicle equipment such as a vehicle ECU 40 or another relay apparatus.

The touch panel 34 includes a display panel such as a liquid-crystal panel or an electroluminescent (EL) panel, and a touch sensor. The touch sensor detects a touch operation by the streamer S on the touch panel 34 and outputs position information indicating a position of the detected touch operation to a first control section 330.

For example, the speech processing unit 35 converts digital speech data output by the first control section 330 into an analog speech signal. The speech processing unit 35 amplifies the converted analog speech signal and outputs the amplified speech signal via the speaker 36.

The in-vehicle ECU 300 includes an input/output I/F 310 and the first control section 330.

The input/output I/F 310 functions as a connection unit between the first control section 330 and the external communication I/F 31, the in-vehicle short-range wireless communication I/F 32, the internal communication I/F 33, the touch panel 34, and the speech processing unit 35. The input/output I/F 310 includes a connector and an interface circuit. The input/output I/F 310 outputs data input from the external communication I/F 31, the in-vehicle short-range wireless communication I/F 32, the internal communication I/F 33, the touch panel 34, and the speech processing unit 35 to the first control section 330. The input/output I/F 310 outputs data input from the first control section 330 to the external communication I/F 31, the in-vehicle short-range wireless communication I/F 32, the internal communication I/F 33, the touch panel 34, or the speech processing unit 35.

The first control section 330 is a computer apparatus including a first memory 340 and a first processor 350.

The first memory 340 includes, for example, a volatile semiconductor memory and a non-volatile semiconductor memory. The first memory 340 may include only a non-volatile semiconductor memory. The first memory 340 may include an auxiliary storage apparatus such as a solid-state drive (SSD). The first memory 340 stores a control program 345 executed by the first processor 350, configuration data that defines an operation of the in-vehicle apparatus 30, and the like.

The first processor 350 is, for example, an arithmetic processing apparatus such as a central processing unit (CPU) or a microprocessing unit (MPU). The first processor 350 may be implemented as a single processor or as a plurality of processors. The first processor 350 may be implemented as a system on a chip (SoC) integrated with part or all of the first memory 340, or with another circuit.

The in-vehicle ECU 300 receives a captured image, speech, and the like from the streamer terminal 100, and uploads the received captured image, speech, and the like to the streaming server 200.

### 3. Configuration of Streaming Server

Next, the configuration of the streaming server 200 will be described.

The streaming server 200 includes a network communication I/F 210 and a second control section 230.

For example, the network communication I/F 210 includes a communication card such as a network interface card (NIC), and performs mutual data communication via the communication network 5 with the in-vehicle apparatus 30, the streamer terminal 100, and the display device 400.

The second control section 230 is a computer apparatus including a second memory 240 and a second processor 250.

The second memory 240 includes, for example, a volatile semiconductor memory and a non-volatile semiconductor memory. The second memory 240 may include only a non-volatile semiconductor memory. The second memory 240 may include an auxiliary storage apparatus such as a hard disk drive (HDD) or an SSD.

The second memory 240 stores a control program 241 executed by the second processor 250, a user registration database 243, a stream management database 245, and a content database 247. Hereinafter, database will be abbreviated as DB.

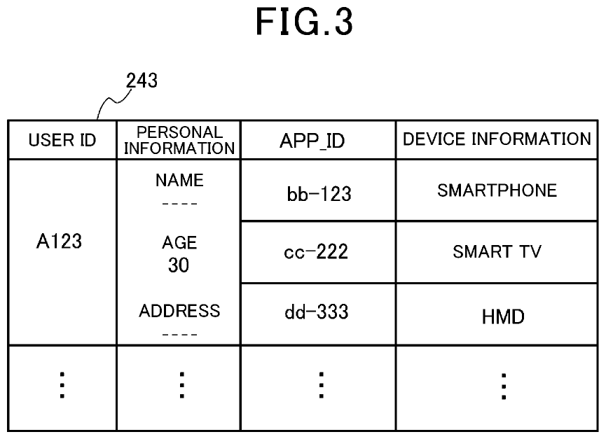

FIG. 3 is a diagram showing a configuration of the user registration DB 243.

One record in the user registration DB 243 includes a user ID, personal information of a user, APP_ID, and device information. APP is an abbreviation of application program.

The user ID is identification information for identifying a user utilizing an image streaming service provided by the streaming server 200. The user includes the streamer S and the viewer U.

The personal information is personal information of the streamer S and the viewer U being the user. The personal information includes, for example, information such as name, address, sex, and age.

APP_ID is identification information for identifying the application program downloaded and installed on the streamer terminal 100 or the display device 400.

The streamer S and the viewer U download the APP from a predetermined website and respectively install the APP on the streamer terminal 100 and the display device 400.

The device information is information indicating whether the display device 400 on which the APP indicated by APP_ID is installed is the first display device 400A or the second display device 400B. That is, the device information is information indicating whether the display device 400 is a head-mounted display apparatus, or an apparatus other than the head-mounted display apparatus such as a smartphone, a tablet PC, or a notebook PC. The device information includes, for example, communication information regarding the display device 400, such as an IP address.

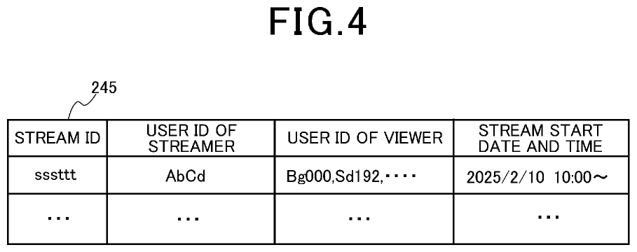

FIG. 4 is a diagram showing a configuration of the stream management DB 245.

One record in the stream management DB 245 includes a stream ID for identifying a stream, the user ID of the streamer S, the user ID of the viewer U, and a stream start date and time.

Returning to FIG. 2, the configuration of the streaming server 200 will be described further.

The second processor 250 is, for example, an arithmetic processing apparatus such as a CPU or an MPU. The second processor 250 may be implemented as a single processor or as a plurality of processors. The second processor 250 may be implemented as an SoC integrated with part or all of the second memory 240, or with another circuit.

The second control section 230 registers, in a content DB 247, content data including a streaming image and speech uploaded from the streamer terminal 100. Upon receiving a streaming request, the second control section 230 reads the content data specified by the received streaming request from the content DB 247 and streams the read content data to the display device 400 being the origin of the streaming request.

### 4. Configuration of Streamer Terminal

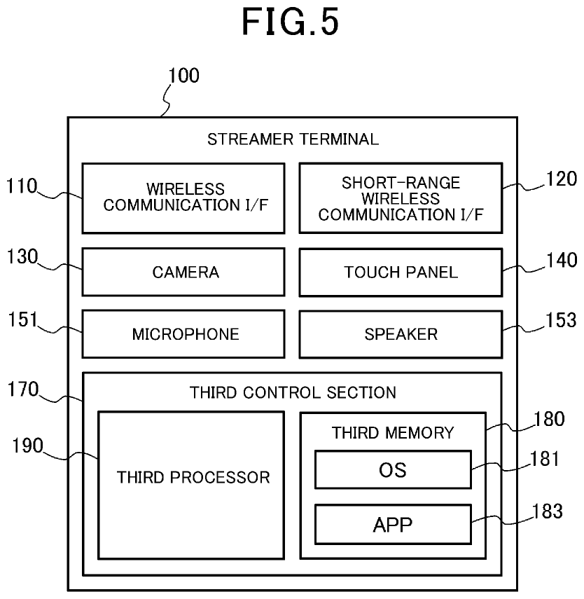

FIG. 5 is a block diagram showing a configuration of the streamer terminal 100.

The streamer terminal 100 includes a wireless communication I/F 110, a short-range wireless communication I/F 120, a camera 130, a touch panel 140, a microphone 151, a speaker 153, and a third control section 170.

The wireless communication I/F 110 is a communication module that performs wireless communication in accordance with a mobile communication standard such as LTE, 4G, 5G, or Wi-Fi. The wireless communication I/F 110 is connected to the communication network 5 via an antenna (not shown) and performs mutual data transmission/reception with the streaming server 200.

For example, the short-range wireless communication I/F 120 is a communication module that performs communication in accordance with an NFC standard such as Bluetooth or Wi-Fi. The short-range wireless communication I/F 120 transmits a captured image captured by the camera 130, speech input via the microphone 151, and the like to the in-vehicle apparatus 30 through short-range wireless communication with the in-vehicle apparatus 30.

The camera 130 is a capturing apparatus including an image sensor and a data processing circuit. The image sensor is implemented as, for example, a charge-coupled device (CCD) or a complementary metal-oxide-semiconductor (CMOS). The data processing circuit generates a captured image from an output of the image sensor. The captured image generated by the camera 130 is transmitted to the in-vehicle apparatus 30 under the control of the third control section 170.

The touch panel 140 includes a display panel such as a liquid-crystal panel or an EL panel, and a touch sensor. The touch panel 140 functions as a display part for displaying an image and as a reception part for accepting an operation by the streamer S.

The microphone 151 is a speech input apparatus for inputting speech of the streamer S, and the speaker 153 is a speech output apparatus for outputting speech of the viewer U and the like.

The third control section 170 is a computer apparatus including a third memory 180 and a third processor 190.

The third memory 180 includes a non-volatile semiconductor memory. The third memory 180 may include an auxiliary storage apparatus such as an SD card. The third memory 180 stores control programs such as an operating system (OS) 181 and an APP 183. The APP 183 is an application program that performs mutual data communication with the streaming server 200, displays a moving image included in content streamed by the streaming server 200 on the touch panel 140, and outputs speech included in the content to the speaker 153.

The third processor 190 is, for example, an arithmetic processing apparatus such as a CPU or an MPU. The third processor 190 may be implemented as a single processor or as a plurality of processors.

### 5. Configuration of Display Device

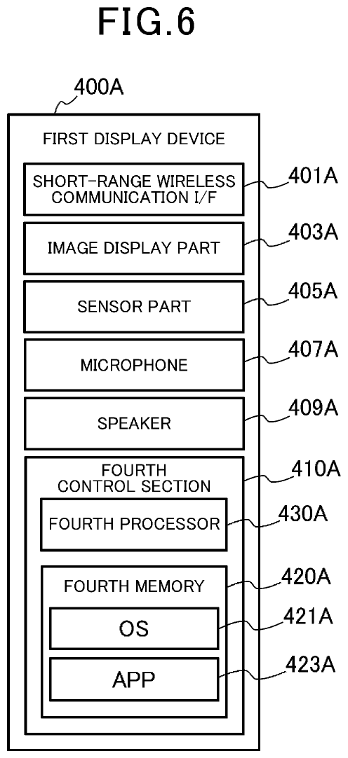

FIG. 6 is a block diagram showing a configuration of the first display device 400A.

The first display device 400A includes a short-range wireless communication I/F 401A, an image display part 403A, a sensor part 405A, and a fourth control section 410A.

For example, the short-range wireless communication I/F 401A is a communication module that performs communication in accordance with an NFC standard such as Bluetooth or Wi-Fi. The short-range wireless communication I/F 401A can be wirelessly connected to the communication network 5 via a Wi-Fi router (not shown) installed in the home or the like of the viewer U.

The image display part 403A includes a display panel (not shown) such as a liquid-crystal panel or an organic EL panel, a light guide plate that emits image light emitted from the display panel toward the eyes of viewer U, and the like. The image display part 403A is mounted on the head of viewer U.

For example, the sensor part 405A is installed in the image display part 403A and detects movement of the head of the viewer U. The sensor part 405A is, for example, a motion sensor including a three-axis accelerometer and a three-axis gyroscope. The sensor part 405A may include a three-axis magnetometer. In this case, the sensor part 405A may be an inertial measurement unit (IMU) in which the three-axis accelerometer, the three-axis gyroscope, and the three-axis magnetometer are modularized.

A microphone 407A collects the speech emitted by the viewer U, and a speaker 409A outputs the speech.

The fourth control section 410A is a computer apparatus including a fourth memory 420A and a fourth processor 430A.

The fourth memory 420A includes a non-volatile semiconductor memory. The fourth memory 420A may include a volatile semiconductor memory and a non-volatile semiconductor memory. The fourth memory 420A stores an OS 421A and an APP 423A. The APP 423A is an application program that performs mutual data communication with the streaming server 200, displays a moving image included in content streamed by the streaming server 200 on the image display part 403A, and outputs speech included in the content to the speaker 409A.

The fourth processor 430A is, for example, an arithmetic processing apparatus such as a CPU or an MPU. The fourth processor 430A may be implemented as a single processor or as a plurality of processors.

The viewer U boots the APP 423A to, for example, access a web page provided by the streaming server 200 and select a channel and a program the viewer U wants to watch from among programs offered by the streaming server 200. When the viewer U selects a channel and a program, the fourth control section 410A transmits a streaming request including the user ID, APP_ID, channel information, and program information to the streaming server 200.

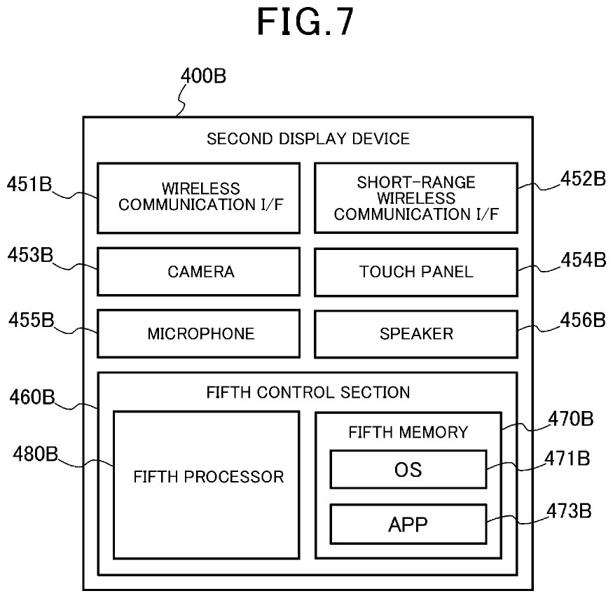

FIG. 7 is a block diagram showing a configuration of the second display device 400B.

The second display device 400B shown in FIG. 7 includes a wireless communication I/F 451B, a short-range wireless communication I/F 452B, a camera 453B, a touch panel 454B, a microphone 455B, a speaker 456B, and a fifth control section 460B. Since the configuration of the second display device 400B is identical to the configuration of the streamer terminal 100 shown in FIG. 5, description thereof will be omitted.

### 6. Operation of Streaming Server

Next, an operation of the streaming server 200 will be described.

Upon receiving the streaming request from the display device 400, the second control section 230 of the streaming server 200 acquires the user ID, the channel information requesting streaming, and APP_ID included in the received streaming request. The second control section 230 acquires the device information of the display device on which the APP with acquired APP_ID is installed from the user registration DB 243.

When a type of the display device indicated by the acquired device information is the first display device 400A, the second control section 230 starts streaming in a first display mode. Display modes include the first display mode corresponding to the first display device 400A and a second display mode corresponding to the second display device 400B.

The first display mode is a mode in which a range of the captured image to be streamed as the streaming image is changed in accordance with the movement of the head of the viewer U on which the first display device 400A is mounted.

When the display mode is the first display mode, the second control section 230 determines the range of the captured image to be streamed as the streaming image based on movement information indicating the movement of the head of the viewer U received from the first display device 400A, and streams the captured image in the determined range as the streaming image.

When the display mode is the first display mode, the second control section 230 continuously receives sensor data indicating the movement of the head of the viewer U from the first display device 400A. The movement of the head of the viewer U indicated by the sensor data includes movement of the head of a user in an up-down direction, a left-right direction, and the like. The second control section 230 determines a range to be cropped from the captured image as the streaming image, based on the sensor data received from the first display device 400A.

For example, when the viewer U rotates their head to the right, the second control section 230 moves the range to be cropped from the captured image to the right by a movement amount corresponding to an identified rotation amount of the head.

When the viewer U rotates their head to the left, the second control section 230 moves the range to be cropped from the captured image to the left by a movement amount corresponding to the identified rotation amount of the head.

The second display mode is a display mode in which the range of the streaming image to be streamed to the display device 400 is fixed. When the display mode is the second display mode, the second control section 230 crops at all times a certain range of the captured image uploaded from the in-vehicle apparatus 30 and streams an image of the cropped range as the streaming image.

When the type of the display device indicated by the acquired device information is the first display device 400A, the second control section 230 streams a streaming image of a channel corresponding to the channel information to the first display device 400A corresponding to APP_ID. The second control section 230 receives the sensor data indicating the movement of the head of the viewer U from the first display device 400A at predetermined intervals. The second control section 230 changes the range to be cropped from the captured image as the streaming image, based on the movement of the head of the viewer U indicated by the received sensor data.

For example, when another display device 400 is connected to a network setup using a Wi-Fi router or the like, the first display device 400A can transfer the streaming image received from the streaming server 200 to the other display device 400 through mirroring.

When mirroring the streaming image to the other display device, the first display device 400A acquires device information from the display device being mirrored and transmits a mirroring notification including the acquired device information to the streaming server 200.

When the first display device 400A receives the mirroring notification, the second control section 230 does not reflect data, among the sensor data received from the first display device 400A, indicating the movement of the head of the user in the up-down direction in the range to be cropped as the streaming image. The sensor data received from the first display device 400A also includes the data indicating the movement of the head of the user. Upon receiving the mirroring notification from the first display device 400A, the second control section 230 determines a range of the captured image to be streamed as the streaming image, excluding the movement of the head of the user indicated by the sensor data. The second control section 230 may determine the range to be cropped as the streaming image so that the range to be cropped as the streaming image is smaller than the range of the movement of the head of the user indicated by the sensor data.

Upon receiving the mirroring notification from the first display device 400A, the second control section 230 calculates a rotation speed of the head of the user based on the sensor data. The second control section 230 determines whether the calculated rotation speed of the head is greater than or equal to a threshold value. The rotation speed of the head here may also include the movement in the up-down direction. Upon determining that the rotation speed of the head is greater than or equal to a preset threshold value, the second control section 230 reduces a frame rate of the streaming image to be streamed to the first display device 400A by a predetermined value. The second control section 230 reduces the frame rate by the predetermined value before the rotation speed of the head becomes greater than or equal to the preset threshold value.

Furthermore, the second control section 230 continuously calculates the rotation speed of the head of the user based on sensor data, and determines whether a state continues for a preset amount of time or longer in which the rotation speed of the head is greater than or equal to the preset threshold value.

When the state continues for the preset amount of time or longer in which the rotation speed of the head of the user is greater than or equal to the threshold value, the second control section 230 displays, on the display device indicated by the device information received from the first display device 400A, a prompt inquiring whether to start image streaming to this display device. Upon receiving a response from the display device to start streaming, the second control section 230 transmits an instruction to the first display device 400A to end mirroring and starts streaming the streaming image to the display device.

When the rotation speed of the head of the user becomes less than the threshold value, the second control section 230 displays, on the display device performing the image streaming, a prompt inquiring whether to end the image streaming. When receiving a response from the display device to permit ending the streaming, the second control section 230 transmits an instruction to the first display device 400A to start mirroring and ends the image streaming to the display device.

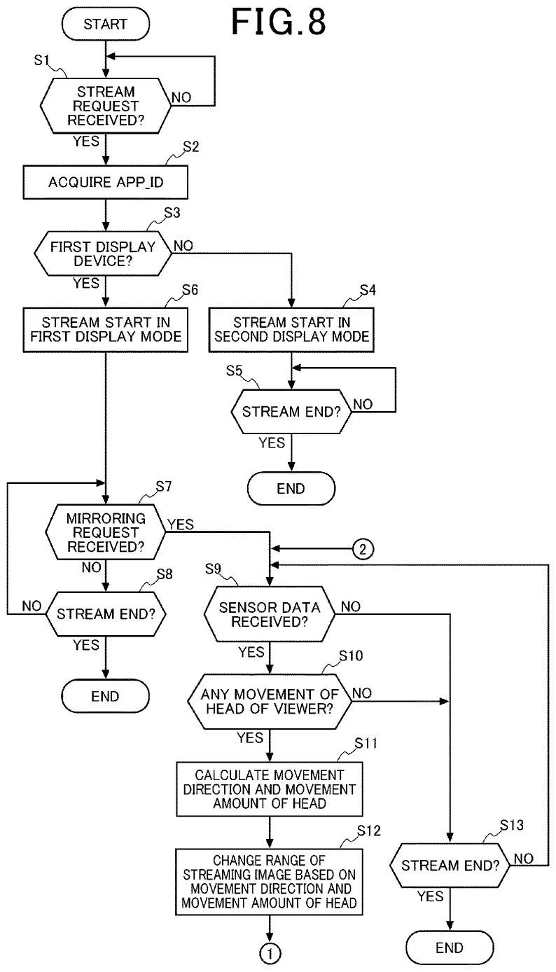

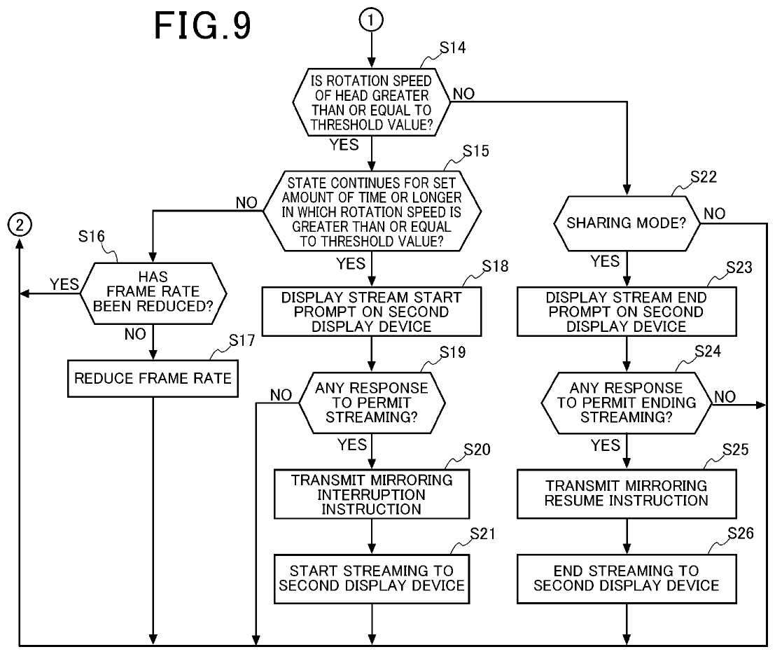

FIGS. 8 and 9 are flowcharts showing the operation of the streaming server 200. The operation of the streaming server 200 will be described with reference to the flowcharts shown in FIGS. 8 and 9.

First, the second control section 230 determines whether a streaming request has been received (step S1). When a streaming request has not been received (NO in step S1), the second control section 230 stands by until a streaming request is received.

Upon receiving a streaming request, (YES in step S1), the second control section 230 acquires APP_ID included in the received streaming request (step S2). The second control section 230 acquires, with reference to the user registration DB 243, device information of a display device on which an APP corresponding to acquired APP_ID is installed.

Next, the second control section 230 determines whether a transmission source of the streaming request is the first display device 400A based on the acquired device information (step S3). Upon determining that the transmission source of the streaming request is not the first display device 400A (NO in step S3) but the second display device 400B, the second control section 230 starts streaming a streaming image to the transmission source of the streaming request in the second display mode (step S4). That is, the second control section 230 crops at all times a certain range of a captured image uploaded from the in-vehicle apparatus 30 and streams an image of the cropped range as the streaming image.

Next, the second control section 230 determines whether a stream of a channel currently streaming the streaming image has ended (step S5). When the stream has not ended (NO in step S5), the second control section 230 stands by until the stream ends. When the stream ends (YES in step S5), the second control section 230 ends this processing flow.

Next, when determining that the transmission source of the streaming request is the first display device 400A (YES in step S3), the second control section 230 starts streaming the streaming image to the first display device 400A being the transmission source of the streaming request in the first display mode (step S6).

Next, the second control section 230 determines whether a mirroring notification has been received from the first display device 400A having started the stream (step S7). When a mirroring notification has not been received from the first display device 400A (NO in step S7), the second control section 230 determines whether the stream of the channel currently streaming the streaming image has ended (step S8). When the stream has not ended (NO in step S8), the second control section 230 returns to the determining of step S7. When the stream ends (YES in step S8), the second control section 230 ends this processing flow.

Next, upon receiving a mirroring notification from the first display device 400A (YES in step S7), the second control section 230 determines whether sensor data transmitted from the first display device 400A has been received (step S9). When sensor data has not been received from the first display device 400A (NO in step S9), the second control section 230 determines whether the stream has ended (step S13).

When the stream ends (YES in step S13), the second control section 230 ends this processing flow. When the stream has not ended (NO in step S13), the second control section 230 returns to the determining of step S9 and determines whether sensor data has been received.

Next, upon receiving sensor data from the first display device 400A currently streaming the streaming image (YES in step S9), the second control section 230 determines whether there is movement of the head of the viewer U based on the received sensor data (step S10). Upon determining that there has not been any movement of the head of the viewer U (NO in step S10), the second control section 230 transitions to the determining of step S13.

Upon determining that there is movement of the head of the viewer U (YES in step S10), the second control section 230 calculates a movement direction and movement amount of the head of the viewer U (step S11). The second control section 230 changes the range to be cropped from the captured image as the streaming image, based on the calculated movement direction and movement amount of the head of the viewer U (step S12). At this time, the second control section 230 determines the range to be cropped as the streaming image so that the range to be cropped as the streaming image is smaller than a range of the movement of the head of the user indicated by the sensor data. When the movement of the head of the user includes movement in the up-down direction, the second control section 230 does not change the range to be cropped as the streaming image in the up-down direction in accordance with the movement of the head of the user in the up-down direction. The second control section 230 streams, to the first display device 400A, the streaming image whose cropped range has been changed.

The operation of the streaming server 200 will be further described with reference to the flowchart shown in FIG. 9.

Next, the second control section 230 determines whether a rotation speed of the head of the viewer U is greater than or equal to a preset threshold value (step S14). When the rotation speed of the head of the user is equal to or greater than the preset threshold value (YES in step S14), the second control section 230 determines whether a state has continued for a set amount of time or longer in which the rotation speed is equal to or greater than the threshold value (step S15).

Upon determining that the state in which the rotation speed of the head is greater than or equal to the preset threshold value is shorter than the set amount of time (NO in step S15), the second control section 230 determines whether a frame rate of the streaming image to be streamed to the first display device 400A has been reduced by a predetermined value (step S16). When the frame rate of the streaming image has been reduced by the predetermined value (YES in step S16), the second control section 230 returns to the determining of step S9 of the flowchart shown in FIG. 8.

When the frame rate of the streaming image has not been reduced by the predetermined value (NO in step S16), the second control section 230 reduces the frame rate of the streaming image to be streamed to the first display device 400A by the predetermined value (step S17). Subsequently, the second control section 230 returns to the determining of step S9 of the flowchart shown in FIG. 8.

Upon determining that the state has continued for the set amount of time or longer in which the rotation speed of the head is greater than or equal to the preset threshold value (YES in step S15), the second control section 230 acquires the device information included in the mirroring notification received in step S7. Here, a case will be described in which the device information of the second display device 400B is acquired as the device information, but the device information may also be that of the first display device 400A. The second control section 230 displays, on the second display device 400B corresponding to the device information, a stream start prompt for inquiring whether to start streaming the streaming image currently being streamed to the first display device 400A (step S18).

Next, the second control section 230 determines whether a response has been received from the second display device 400B to permit streaming (step S19). When a response to permit streaming has not been received (NO in step S19), the second control section 230 returns to the determining of step S9 of the flowchart shown in FIG. 8.

Upon receiving a response from the second display device 400B to permit streaming (YES in step S19), the second control section 230 transmits a mirroring interruption instruction to the first display device 400A (step S20) and starts streaming to the display device (step S21).

Upon determining in the determining of step S14 that the rotation speed of the head is less than the threshold value (NO in step S14), the second control section 230 determines whether a sharing mode is currently being executed in which the streaming server 200 streams the same streaming image to a plurality of display devices (step S22). That is, the second control section 230 determines whether streaming to the second display device 400B has been started in step S21.

When the sharing mode is not being executed (NO in step S22), the second control section 230 returns to the determining of step S9 of the flowchart shown in FIG. 8. When the sharing mode is being executed (YES in step S22), the second control section 230 displays, on the second display device 400B, a stream end prompt to end streaming the streaming image currently being streamed (step S23).

Next, the second control section 230 determines whether a response has been received from the second display device 400B to permit ending the streaming (step S24). When a response to permit ending the streaming has not been received (NO in step S24), the second control section 230 returns to the determining of step S9 of the flowchart shown in FIG. 8.

Upon receiving a response from the display device to permit ending the streaming (YES in step S24), the second control section 230 transmits a mirroring resume instruction to the first display device 400A (step S25). Subsequently, the second control section 230 ends streaming the streaming image to the second display device 400B (step S26).

### 7. Variations

The above-described embodiment is a preferred embodiment of the present invention. However, the present invention is not limited to the above-described embodiment, and various modifications may be made without departing from the spirit of the present invention.

For example, a case has been described in the above-described embodiment in which the range of the captured image to be streamed as the streaming image is made smaller than the range of the movement in the up-down direction indicated by the movement information or the range of the captured image is not changed in the up-down direction, when streaming the streaming image to the first display device 400A. Similarly, when streaming the streaming image to the second display device 400B, control may be performed so that the range of the captured image to be streamed as the streaming image is made smaller than the range of the movement in the up-down direction indicated by the movement information or the range of the captured image is not changed in the up-down direction. In this case, a motion sensor is installed in the second display device 400B similarly to the first display device 400A, and the movement of the second display device 400B is detected by this motion sensor.

For example, the first display device 400A and the second display device 400B may be directly connected via Bluetooth, Wi-Fi Direct, or the like, and the first display device 400A may operate as the streaming server 200. In this case, the first display device 400A receives the movement information indicating the movement of the second display device 400B from the second display device 400B, determines the range of the captured image to be streamed as the streaming image based on the received movement information, and streams the captured image in the determined range to the second display device 400B as the streaming image.

The first display device 400A or the second display device 400B may be configured so that the range of the streaming image displayed on the second display device 400B is not changed in the up-down direction.

For example, when the movement information acquired from the second display device 400B includes the movement in the up-down direction, the first display device 400A may be controlled so that the range of the captured image to be streamed as the streaming image is made smaller than the range of the movement in the up-down direction indicated by the movement information or the range of the captured image is not changed in the up-down direction. When the streaming image streamed from the first display device 400A includes the movement in the up-down direction, the second display device 400B may crop a certain central range of the streaming image, generate a streaming image without movement in the up-down direction, and display the generated streaming image.

For example, in the above-described embodiment, a case has been described in which an inside of the vehicle 3 is captured by one streamer terminal 100, but a plurality of streamer terminals 100 may be installed in the vehicle 3 and the inside of the vehicle 3 may be captured by this plurality of streamer terminals 100.

In the above-described embodiment, a configuration is shown in which the streamer terminal 100 and the in-vehicle apparatus 30 are connected via short-range wireless communication and the captured image is transmitted from the streamer terminal 100 to the in-vehicle apparatus 30, but the streamer terminal 100 may upload the captured image to the streaming server 200 and the streaming server 200 may upload the captured image to the in-vehicle apparatus 30. The streamer S visually recognizes a preview image of the captured image displayed on the touch panel 34 of the in-vehicle apparatus 30 and adjusts an angle of view of the streamer terminal 100 being a capturing apparatus.

In the above-described embodiment, a case has been described in which the captured image taken by the streamer terminal 100 is transmitted to the streaming server 200 by the in-vehicle apparatus 30, but the streamer terminal 100 may transmit the captured image taken by the streamer terminal 100 to the streaming server 200.

The processing units in the flowcharts shown in FIGS. 8 and 9 are divided in accordance with their main processing content to facilitate understanding of the processing performed by the streaming server 200. The present invention is not limited by the manner in which the processing units in the flowcharts of FIGS. 8 and 9 are divided or by the names assigned to those processing units. The processing performed by the streaming server 200 can be divided into a greater number of processing units in accordance with the processing content, or can be divided so that one processing unit includes a greater amount of processing. The order of the processing in the above flowcharts is not limited to the examples shown in the figures.

In steps S19 and S24 of the flowchart shown in FIG. 9, inquiries are made whether to start and to end streaming to the second display device 400B, but the streaming to the second display device 400B may be started or ended without inquiring whether to do so.

### 8. Configurations Supported by the Above-Described Embodiment

The above embodiment is a specific example of the following configurations.

### Configuration 1

A streaming apparatus including: a communication unit configured to receive a streaming request; a storage unit configured to: store, in association with each other, user identification information for identifying a user and device information for identifying a display device used by the user; and store a captured image for streaming received from a streamer terminal; and a control section configured to: acquire user identification information included in the streaming request and device information; receive, from a display device, movement information indicating movement of the display device indicated by the acquired device information; determine, based on the received movement information, a range of the captured image to be streamed as a streaming image; and stream, to the display device, the captured image in the determined range as the streaming image, wherein when the movement information includes movement in an up-down direction, the control section makes the range of the captured image to be streamed as the streaming image smaller than a range of the movement in the up-down direction indicated by the movement information or does not change the range of the captured image in the up-down direction.

According to the streaming apparatus of configuration 1, when streaming the streaming image to the display device, the range of the captured image to be streamed as the streaming image is determined based on the movement information indicating the movement of the display device and the captured image in the determined range is streamed to the display device as the streaming image. When the movement information includes the movement of the display device in the up-down direction, the range of the captured image to be streamed as the streaming image is made smaller than the range of the movement in the up-down direction indicated by the movement information or the range of the captured image is not changed in the up-down direction. Accordingly, it is possible to reduce dizziness experienced by a user viewing the streaming image.

### Configuration 2

The streaming apparatus according to configuration 1, wherein the control section: when the display device indicated by the device information is a head-mounted first display device, receives the movement information indicating movement of a head of a user on which the first display device is mounted from the first display device; and when the movement information includes movement of the head of the user in the up-down direction, makes the range of the captured image to be streamed as the streaming image smaller than a range of the movement in the up-down direction indicated by the movement information or does not change the range of the captured image in the up-down direction.

According to the streaming apparatus of configuration 2, when the movement information includes the movement of the head of the user in the up-down direction, the range of the captured image to be streamed as the streaming image is made smaller than the range of the movement in the up-down direction indicated by the movement information or the range of the captured image is not changed in the up-down direction. Accordingly, it is possible to reduce dizziness experienced by the user viewing the streaming image.

### Configuration 3

The streaming apparatus according to configuration 2, wherein when the first display device transfers the streaming image to a second display device other than a head-mounted device and when the movement information includes the movement of the head of the user in the up-down direction, the control section makes the range of the captured image to be streamed as the streaming image smaller than the range of the movement in the up-down direction indicated by the movement information or does not change the range of the captured image in the up-down direction.

According to the streaming apparatus of configuration 3, when the first display device transfers the streaming image to the second display device and when the movement information includes the movement of the head of the user in the up-down direction, the range of the captured image to be streamed as the streaming image is made smaller than the range of the movement in the up-down direction indicated by the movement information or the range of the captured image is not changed in the up-down direction. Accordingly, it is possible to suppress dizziness experienced by the user viewing the streaming image on the second display device.

### Configuration 4

The streaming apparatus according to configuration 1, wherein when a speed of the movement indicated by the movement information is greater than or equal to a preset threshold value, the control section changes a frame rate of the streaming image to be streamed to the display device to be less than when the speed of the movement is less than the threshold value.

According to the streaming apparatus of configuration 4, when the speed of the movement indicated by the movement information is greater than or equal to the preset threshold value, the frame rate of the streaming image to be streamed to the first display device is changed to be less. Accordingly, it is possible to suppress dizziness experienced by the user when viewing the streaming image transferred from the first display device on the second display device.

### Configuration 5

The streaming apparatus according to configuration 3, wherein the control section: when a plurality of pieces of device information are associated with the acquired user identification information and when a plurality of display devices corresponding to the plurality of pieces of device information includes the first display device and the second display device, executes a shared streaming mode in which the streaming image is streamed to the plurality of display devices corresponding to the plurality of pieces of device information; and when a state continues for a preset amount of time or longer in which a speed of the movement of the head of the user is greater than or equal to a threshold value, displays prompt information on the second display device to prompt streaming in a display mode of the second display device in which the range of the captured image used as the streaming image is not changed.

According to the streaming apparatus of configuration 5, when the state continues for the preset amount of time or longer in which the speed of the movement of the head of the user is greater than or equal to the threshold value, the prompt information is displayed on the second display device. This prompt information is information for prompting streaming in the display mode of the second display device in which the range of the captured image used as the streaming image is not changed. Accordingly, it is possible to transition to a sharing mode via an instruction from the user using the second display device and to suppress dizziness experienced by the user when viewing on the second display device.

### Configuration 6

The streaming apparatus according to configuration 5, wherein the control section: when the speed of the movement of the head of the user becomes less than the threshold value in the shared streaming mode, instructs the first display device to transfer the streaming image to the second display device; and ends streaming the streaming image to the second display device.

According to the streaming apparatus of configuration 6, when the speed of the movement of the head of the user becomes less than the threshold value, the first display device is instructed to transfer the streaming image to the second display device and streaming the streaming image to the second display device is ended. Accordingly, when there is a low possibility of the user experiencing dizziness even when the user views the streaming image on the second display device, it is possible to resume transferring the streaming image from the first display device to the second display device.

### Configuration 7

The streaming apparatus according to configuration 5, wherein the control section: when the speed of the movement of the head of the user becomes less than the threshold value in the shared streaming mode, displays prompt information on the second display device to prompt ending the streaming of the streaming image; and when receiving a notification from the second display device to permit ending the streaming of the streaming image, instructs the first display device to transfer the streaming image to the second display device and end streaming the streaming image to the second display device.

According to the streaming apparatus of configuration 7, when the speed of the movement of the head of the user becomes less than the threshold value, the prompt information is displayed on the second display device to prompt ending the streaming of the streaming image, and when the notification to permit ending the streaming of the streaming image is received, the first display device is instructed to transfer the streaming image to the second display device and end streaming the streaming image to the second display device. Accordingly, when there is a low possibility of the user experiencing dizziness even when the user views the streaming image on the second display device, it is possible to resume transferring the streaming image from the first display device to the second display device.

### Configuration 8

A streaming method performed by a streaming apparatus, the streaming method including: receiving a captured image for streaming from a streamer terminal and storing the received captured image in a storage unit included in the streaming apparatus; receiving a streaming request; acquiring user identification information included in the streaming request and device information; receiving, from a display device, movement information indicating movement of the display device indicated by the acquired device information; and determining, based on the received movement information, a range of the captured image to be streamed as a streaming image, and streaming, to the display device, the captured image in the determined range as the streaming image, wherein the streaming includes, when the movement information includes movement in an up-down direction, making the range of the captured image to be streamed as the streaming image smaller than a range of the movement in the up-down direction indicated by the movement information or not changing the range of the captured image in the up-down direction.

According to the streaming method of configuration 8, it is possible to achieve the same effects as the streaming apparatus of configuration 1.

### Configuration 9

A non-transitory computer-readable storage medium storing a program for causing a computer included in a streaming apparatus to execute: processing of receiving a captured image for streaming from a streamer terminal and storing the received captured image in a storage unit included in the streaming apparatus; processing of receiving a streaming request; processing of acquiring user identification information included in the streaming request and device information; processing of receiving, from a display device, movement information indicating movement of the display device indicated by the acquired device information; and processing of determining, based on the received movement information, a range of the captured image to be streamed as a streaming image, and streaming, to the display device, the captured image in the determined range as the streaming image, wherein the processing of streaming includes, when the movement information includes movement in an up-down direction, making the range of the captured image to be streamed as the streaming image smaller than a range of the movement in the up-down direction indicated by the movement information or not changing the range of the captured image in the up-down direction.

According to the non-transitory computer-readable storage medium storing the program of configuration 9, it is possible to achieve the same effects as the streaming apparatus of configuration 1.

### Reference Signs List

1 streaming system
3 vehicle
5 communication network
30 in-vehicle apparatus
31 external communication interface
32 in-vehicle short-range wireless communication interface
33 internal communication interface
34 touch panel
35 speech processing unit
36 speaker
40 vehicle ECU
100 streamer terminal
110 wireless communication I/F
120 short-range wireless communication I/F
130 camera
140 touch panel
151 microphone
153 speaker
170 third control section
180 third memory
181 OS
183 APP
190 third processor
200 streaming server
210 network communication I/F
230 second control section
240 second memory
241 control program
243 user registration database
245 stream management database
247 content database
250 second processor
290 third processor
300 in-vehicle ECU
310 input/output I/F
330 first control section
340 first memory
345 control program
350 first processor
400A first display device
400B second display device
401A short-range wireless communication I/F
403A image display part
405A sensor part
407A microphone
409A speaker
410A fourth control section
420A fourth memory
421A OS
423A APP
430A fourth processor
451B wireless communication I/F
452B short-range wireless communication I/F
453B camera
454B touch panel
455B microphone
456B speaker
460B fifth control section
470B fifth memory
471B OS
473B APP
480B fifth processor

1. A streaming apparatus comprising:
a communication unit configured to receive a streaming request;
a storage unit configured to:
store, in association with each other, user identification information for identifying a user and device information for identifying a display device used by the user; and
store a captured image for streaming received from a streamer terminal; and
a control section configured to:
acquire user identification information included in the streaming request and device information;
receive, from a display device, movement information indicating movement of the display device indicated by the acquired device information;
determine, based on the received movement information, a range of the captured image to be streamed as a streaming image; and
stream, to the display device, the captured image in the determined range as the streaming image, wherein
when the movement information includes movement in an up-down direction, the control section makes the range of the captured image to be streamed as the streaming image smaller than a range of the movement in the up-down direction indicated by the movement information or does not change the range of the captured image in the up-down direction.

2. The streaming apparatus according to claim 1, wherein
the control section:
when the display device indicated by the device information is a head-mounted first display device, receives the movement information indicating movement of a head of a user on which the first display device is mounted from the first display device; and
when the movement information includes movement of the head of the user in the up-down direction, makes the range of the captured image to be streamed as the streaming image smaller than a range of the movement in the up-down direction indicated by the movement information or does not change the range of the captured image in the up-down direction.

3. The streaming apparatus according to claim 2, wherein
when the first display device transfers the streaming image to a second display device other than a head-mounted device and when the movement information includes the movement of the head of the user in the up-down direction, the control section makes the range of the captured image to be streamed as the streaming image smaller than the range of the movement in the up-down direction indicated by the movement information or does not change the range of the captured image in the up-down direction.

4. The streaming apparatus according to claim 1, wherein
when a speed of the movement indicated by the movement information is greater than or equal to a preset threshold value, the control section changes a frame rate of the streaming image to be streamed to the display device to be less than when the speed of the movement is less than the threshold value.

5. The streaming apparatus according to claim 3, wherein
the control section:
when a plurality of pieces of device information are associated with the acquired user identification information and when a plurality of display devices corresponding to the plurality of pieces of device information includes the first display device and the second display device, executes a shared streaming mode in which the streaming image is streamed to the plurality of display devices corresponding to the plurality of pieces of device information; and
when a state continues for a preset amount of time or longer in which a speed of the movement of the head of the user is greater than or equal to a threshold value, displays prompt information on the second display device to prompt streaming in a display mode of the second display device in which the range of the captured image used as the streaming image is not changed.

6. The streaming apparatus according to claim 5, wherein
the control section:
when the speed of the movement of the head of the user becomes less than the threshold value in the shared streaming mode, instructs the first display device to transfer the streaming image to the second display device; and
ends streaming the streaming image to the second display device.

7. The streaming apparatus according to claim 5, wherein
the control section:
when the speed of the movement of the head of the user becomes less than the threshold value in the shared streaming mode, displays prompt information on the second display device to prompt ending the streaming of the streaming image; and
when receiving a notification from the second display device to permit ending the streaming of the streaming image, instructs the first display device to transfer the streaming image to the second display device and end streaming the streaming image to the second display device.

8. A streaming method performed by a streaming apparatus, the streaming method comprising:
receiving a captured image for streaming from a streamer terminal and storing the received captured image in a storage unit included in the streaming apparatus;
receiving a streaming request;
acquiring user identification information included in the streaming request and device information;
receiving, from a display device, movement information indicating movement of the display device indicated by the acquired device information; and
determining, based on the received movement information, a range of the captured image to be streamed as a streaming image, and streaming, to the display device, the captured image in the determined range as the streaming image, wherein
the streaming includes, when the movement information includes movement in an up-down direction, making the range of the captured image to be streamed as the streaming image smaller than a range of the movement in the up-down direction indicated by the movement information or not changing the range of the captured image in the up-down direction.

9. A non-transitory computer-readable storage medium storing a program for causing a computer included in a streaming apparatus to execute:
processing of receiving a captured image for streaming from a streamer terminal and storing the received captured image in a storage unit included in the streaming apparatus;
processing of receiving a streaming request;
processing of acquiring user identification information included in the streaming request and device information;
processing of receiving, from a display device, movement information indicating movement of the display device indicated by the acquired device information; and
processing of determining, based on the received movement information, a range of the captured image to be streamed as a streaming image, and streaming, to the display device, the captured image in the determined range as the streaming image, wherein
the processing of streaming includes, when the movement information includes movement in an up-down direction, making the range of the captured image to be streamed as the streaming image smaller than a range of the movement in the up-down direction indicated by the movement information or not changing the range of the captured image in the up-down direction.
